(19) United States
(12) Patent Application Publication
(10) Pub. No.: US 2018/0342142 A1
(43) Pub. Date: Nov. 29, 2018

(54) CONCEALED LOCATION TRACKING DEVICE FOR TRACKING LOCATION OF A USER AND METHOD THEREOF

(71) Applicant: Michael Stephen LAU, Houston, TX (US)

(72) Inventor: Michael Stephen LAU, Houston, TX (US)

(21) Appl. No.: 15/975,786

(22) Filed: May 10, 2018

Related U.S. Application Data
(60) Provisional application No. 62/511,281, filed on May 25, 2017.

(51) Int. Cl. G08B 21/02; A41D 1/00

(52) U.S. Cl. CPC G08B 21/0288; G08B 21/0269; A45D 8/36; G08B 21/0294; A41D 1/002; G08B 21/0272

(57) ABSTRACT

A method and system for a location tracking system is disclosed. The location tracking system comprises a wearable object to be worn by a user and a location tracking device to be concealed within a concealing space provided in the wearable object. The location tracking device comprises a satellite communication module, a cellular communication module, a microcontroller and a battery. The satellite communication module determines a primary location information of the location tracking device. The cellular communication module determines a secondary location information of the location tracking device and communicates with a monitoring device. The microcontroller accesses at least one of the primary location information and the secondary location information and enables the cellular communication module to transmit at least one of the primary location information and the secondary location information to the monitoring device. The battery provides power required for operating the location tracking device.

### TECHNICAL FIELD

The present disclosure relates to a wearable location tracking device and, more particularly to, a method and system for tracking location of a user using a concealed location tracking device.

### BACKGROUND

Criminal activities have been on the rise across the globe. In particular, abduction of people for ransom is emerging as a big issue faced by most countries. Such criminal activities pose a huge threat for the safety of vulnerable people, such as kids and women. Police are unable to track down the perpetrators and many innocent people find themselves as victims of heinous crimes resulting from assault to murder.

Although various personal safety devices are available in the market, the use of tracking devices for determining location information of a user is on the rise. The tracking device ensures that the location information is communicated to a help device if a victim, for example, a kid is unable to use personal safety devices to defend themselves or raise an audible alarm in case of emergency. Such tracking devices come in a variety of shapes and sizes and are usually designed as wearables or attached to the user who is monitored to determine location information when lost or abducted. However, in most cases, the tracking device is visible to an abductor who may carefully dismantle or remove it from the victim. For example, wearable tracking devices, such as a watch, a wrist band or pendants employing tracking devices may not evade eyes of the abductors who may forcibly remove and discard the tracking device from the victim.

Recently, with rapid growth and deployment wireless technology for a variety of applications, wireless technology has also made a foray into personal safety devices given the broad range of features and functions it possesses. Most of the tracking devices employ Global Positioning Systems (GPS) for determining the location information of the person. However, GPS signals may not be accurate due to some obstacles such as buildings, trees and sometimes due to extreme atmospheric conditions such as geomagnetic storms. In such cases, it is increasingly difficult and may result in a huge delay of tracking down a victim equipped with the tracking device until the exact location of the victim is determined.

### SUMMARY

Various embodiments of the present disclosure provide a system and a method for tracking location of a person using a concealed location tracking device.

In an embodiment, a location tracking system is disclosed. The location tracking system includes a wearable object and a location tracking device. The wearable object is configured to be worn by a user and comprises a concealing space. The location tracking device is configured to be concealed within the concealing space and has a strip-like profile. The location tracking device comprises a satellite communication module, a cellular communication module, a microcontroller and a wireless chargeable battery. The satellite communication module determines a primary location information of the location tracking device. The cellular communication module determines a secondary location information of the location tracking device and communicates with a monitoring device. The microcontroller is electronically coupled with the satellite communication module and the cellular communication module. The microcontroller is configured to access a location information, wherein the location information is at least one of the primary location information and the secondary location information. The microcontroller enables the cellular communication module to transmit at least one of the primary location information and the secondary location information to the monitoring device. The wireless chargeable battery is used for powering the location tracking device.

In another embodiment a location tracking system is disclosed. The location tracking system includes a garment, a location tracking device and a monitoring device. The garment is configured to be worn by a user, and comprises a concealing space therein. The location tracking device is configured to be concealed within the concealing space and has a strip-like profile. The location tracking device comprises a satellite communication module, a cellular communication module, a microcontroller and a wireless chargeable battery. The satellite communication module determines a primary location information of the location tracking device. The cellular communication module determines a secondary location information of the location tracking device. The microcontroller is electronically coupled with the satellite communication module and the cellular communication module. The microcontroller is configured to access a location information, wherein the location information is at least one of the primary location information and the secondary location information. The wireless chargeable battery is used for powering the location tracking device. The monitoring device is communicably coupled with the location tracking device for enabling the cellular communication module to transmit at least one of the primary location information and the secondary location information to the monitoring device.

In yet another embodiment a method for determining a location information of a user associated with a location tracking device is disclosed. The method includes causing a provisioning of at least one UI on a display screen of a monitoring device for receiving a user request to access the location information of the location tracking device. The method includes accessing the location information of the location tracking device upon receipt of the user request. The location information is at least one of a primary location information from a satellite communication module and a secondary location information from a cellular communication module. The secondary location information is accessed when the primary location information is not accessible. The method further includes facilitating display of the location information of the tracking device on the UI of the monitoring device.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an environment, where at least some example embodiment can be practiced;

FIG. 2A illustrates a schematic representation of a location tracking device, in accordance with an example embodiment;

FIG. 2B illustrates a block diagram of the location tracking device of FIG. 2A, in accordance with an example embodiment;

FIG. 3A is a sequence flow diagram for tracking location of a user associated with the location tracking device of FIG. 2B, in accordance with an example embodiment;

FIG. 3B is a sequence flow diagram for tracking location of a user associated with the location tracking device of FIG. 2B, in accordance with another example embodiment;

FIG. 4A shows an example representation of a UI displayed on the display screen of a monitoring device by a tracking application for receiving user request to track a user, in accordance with an example embodiment;

FIG. 4B shows an example representation of a UI displaying location information of the tracking device associated with a user, in accordance with an example embodiment;

FIG. 4C shows an example representation of displaying history location information of the tracking device of FIG. 2A, in accordance with an example embodiment;

FIG. 5 is a flowchart illustrating a method for determining location information of a user associated with the location tracking device of FIG. 2A, in accordance with an example embodiment;

FIGS. 6A, 6B, 6C, 6D, 6E, 6F illustrate example representations of concealing the location tracking device of FIG. 2A in wearable objects, in accordance with an example embodiment;

FIG. 7 is a block diagram of a monitoring device, in accordance with an example embodiment; and

FIG. 8 is a simplified block diagram of a server, in accordance with an example embodiment.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

In an example scenario, a victim (e.g., the user) may be abducted and determining the location information of the victim poses a huge challenge for police personnel. Furthermore, determining even a relative location information may require the police personnel to enquire and record statements of a number of people that may be misleading and lead to further delay in rescuing the victim.

To address to the challenges in the above scenario, various example embodiments of the present disclosure provide a method and system for determining location information of a user associated with a location tracking device concealed in a wearable object. The wearable object, such as a garment or an accessory is worn by the user and is configured with a concealed space that can encloses a location tracking device. The location tracking device comprises a satellite communication module, a cellular communication module, a microcontroller and a wireless chargeable battery. The satellite communication module is configured to determine a primary location information of the location tracking device associated with the user. The primary location information is determined based on a plurality of satellite signals received from one or more satellites such as reliable positioning systems like GPS, GNSS, Galileo, GLONASS, LORAN, BeiDOU, NAVIC, QZSS or any other. The cellular communication module is configured to determine a secondary location information of the location tracking device associated with the user based on a plurality of cellular signals received from one or more cellular towers. The microcontroller is electronically coupled with the satellite communication module and the cellular communication module. The microcontroller is configured to access the primary location information and/or the secondary location and enable the cellular communication module to transmit at least one of the primary location information and the secondary location information to a monitoring device. In an embodiment, the secondary location information is accessed by the microcontroller only if the primary location information is not available. In general, the primary location information and the secondary location information are same.

The monitoring device is a mobile device equipped with a tracking application and is communicably coupled to the location tracking device. The tracking application is accessed to provide a user request such as to initiate tracking of the location tracking device associated with the user. The microcontroller upon receipt of the user request from the tracking application, prompts the satellite communication module and the cellular communication module to determine the primary location information and the secondary location information, respectively. In some embodiments, the cellular communication module determines the secondary location information only when the satellite communication module is unable to determine the primary location information due to various possible reasons. The tracking application is configured to receive the location information (primary location information and the secondary location information) from the cellular communication module and display the location information of the location tracking device associated with the user on a UI of the monitoring device via the tracking application. The location information may be displayed on a map or representative geo-coordinates on the tracking application. The wirelessly chargeable battery is configured to wirelessly charge the battery in the location tracking device using at least one of an inductive charging, magnetic resonance charging, radio frequency charging and ultrasonic sound wave charging.

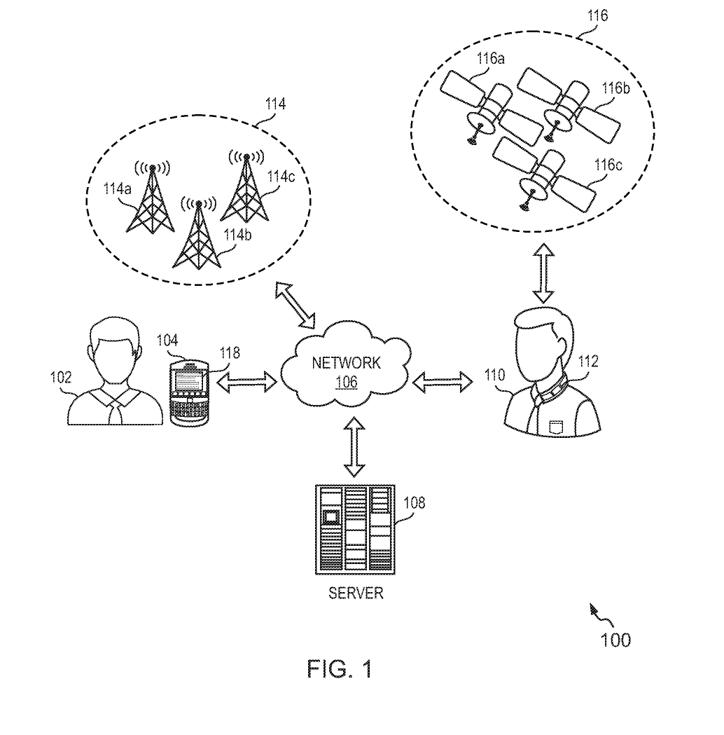

The determination of the location information of the location tracking device is further explained in detail with reference to FIGS. 1-8.

FIG. 1 shows an example representation of an environment 100 in which various embodiments of the present invention may be practiced. The environment 100 depicts two individuals, hereinafter referred to as a user 102 and a user 110, for illustration purposes. The user 102 is depicted to be associated with an electronic device 104 (hereinafter referred to as a ‘monitoring device 104’). The electronic device 104 is exemplarily depicted as a smartphone. It is understood that the electronic device of the user 102 may be embodied in various forms, such as a tablet computer, a wearable device, a personal digital assistant, a personal computer, and the like. The user 110 is depicted to be associated with a wearable object (shirt) for accommodating a location tracking device 112 in a concealing space (e.g., configured within a collar) of the wearable object. The location tracking device 112 has a strip-like profile and is concealed within the concealing space of the wearable object of the user 110. It shall be noted that the wearable object is depicted as a shirt for example purpose only and the wearable object may be any of a garment or an accessory of the user 110 comprising an enclosing space to accommodate the location tracking device 112. The garment can be any of a t-shirt, a short, a track pant, an undergarment and the like. Examples of the accessory can be any of a belt, a hair band, a watch, a wrist band, a chain and the like.

The user 102 accesses a tracking application 118 on the monitoring device 104 for tracking location of the user 110. The tracking application 118 may present one or more UI's on a display screen of the monitoring device 104 for receiving a user request from the user 102 such as to initiate tracking of the location tracking device 112 associated with the user 110. It shall be noted that the tracking application 118 on the monitoring device 104 may be configured to determine location information of one or more location tracking devices associated with one or more users and the user 110 associated with the location tracking device 112 is shown for example purposes only.

The environment 100 includes cellular towers 114a, 114b, 114c (hereinafter referred to as ‘cellular towers 114’) and satellites 116a, 116b, 116c (hereinafter referred to as ‘satellites 116’) that aid in tracking location of the user 110 via the location tracking device 112. Examples of satellites 116 may include satellite systems like GPS, GNSS, Galileo, GLONASS, LORAN, BeiDOU, NAVIC, QZSS or any other. The location tracking device 112 is configured to receive a plurality of signals from one or more satellites of the satellites 116 to determine a primary location information of the location tracking device 112 associated with the user 110. The primary location information may include, among other things, latitude, longitude, altitude and time information of the location tracking device 112. Also, the location tracking device 112 is configured to receive a plurality of signals from one or more cellular towers of the cellular towers 114 via a network 106 to determine a secondary location information of the location tracking device 112. For instance, the location tracking device 112 processes the plurality of signals received from the one or more towers to determine the secondary location information of the user 110 in terms of latitude, longitude, altitude and time. It shall be noted that the cellular towers 114 and satellites are not confined to a pre-defined area and may be distributed over a geographical region. It shall be noted that the cellular towers 114 and the satellites 116 are shown for the sake of simplicity and example purposes only and the location tracking device 112 may receive signals from multiple satellites and cellular towers for a more accurate determination of the location information of the user 110. The examples of the network 106 can be based on any available or to be developed communication protocol such as Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution), or fifth generation (5G) communication protocols, and the like.

In an example scenario, if the user 110 is abducted and held captive in a remote place, the user 102 may track and determine the location information of the user 110 via the location tracking device 112 associated with the user 110. When the user 102 initiates tracking of the user 102 via the tracking application 118, the location tracking device 112 gets activated to determine the primary location information and/or the secondary location information. If the user 110 is holed up in a remote place, for example, forest region, then the primary location information may not be available as the plurality of signals received from the satellites 116 may be distorted. In such cases, the secondary location information determined based on the plurality of signals received from the cellular towers 114 are used to determine location information of the user 110. The location information of the user 110 may be displayed on the tracking application 118 either in form of map or geo-coordinates. In an embodiment, the tracking application 118 displays history location information of the user 110 depicting a path taken by the user 110.

In an embodiment, a server 108 is configured to receive the location information (the primary location information and/or the secondary location information) of the user 110 from the location tracking device 112 and provide the location information to the tracking application 118 of the monitoring device 104. The server 108 may be located at one place or may be distributed at multiple locations. Alternatively, or additionally, the server 108 can be a remote server, such as a cloud based server. In another embodiment, the location tracking device 112 may provide the location information of the user 110 directly to the monitoring device 104 via the tracking application 118.

The tracking application 118 may be an application resting at the server 108. In an embodiment, the server 108 is configured to host and manage the tracking application 118 and communicates with user devices. In an example, the monitoring device 104 may access an instance of the tracking application 118 from the server 108 for installing on the monitoring device 104 using application stores associated with Apple iOS™, Android™ OS, Google Chrome OS, Symbian OS®, Windows Mobile® OS, Windows Phone, BlackBerry® OS, Embedded Linux, web OS, Palm OS® or Palm Web OS™, and the like. Alternatively, the tracking application 118 may be installed as a stand-alone application or may be provided in form of factory settings by the manufacturer of the monitoring device 104.

The monitoring device 104 communicates with the location tracking device 112 via the network 106. The network 106 may include wired networks, wireless networks and combinations thereof. Some examples of the wired networks may include, but are not limited to, Ethernet, Local Area Network (LAN), fiber channel network, and the like. Some examples of the wireless networks may include, but are not limited to, cellular networks, Wi-Fi networks, ZigBee or Bluetooth networks, and the like. An example of a combination of wired and wireless networks includes the Internet.

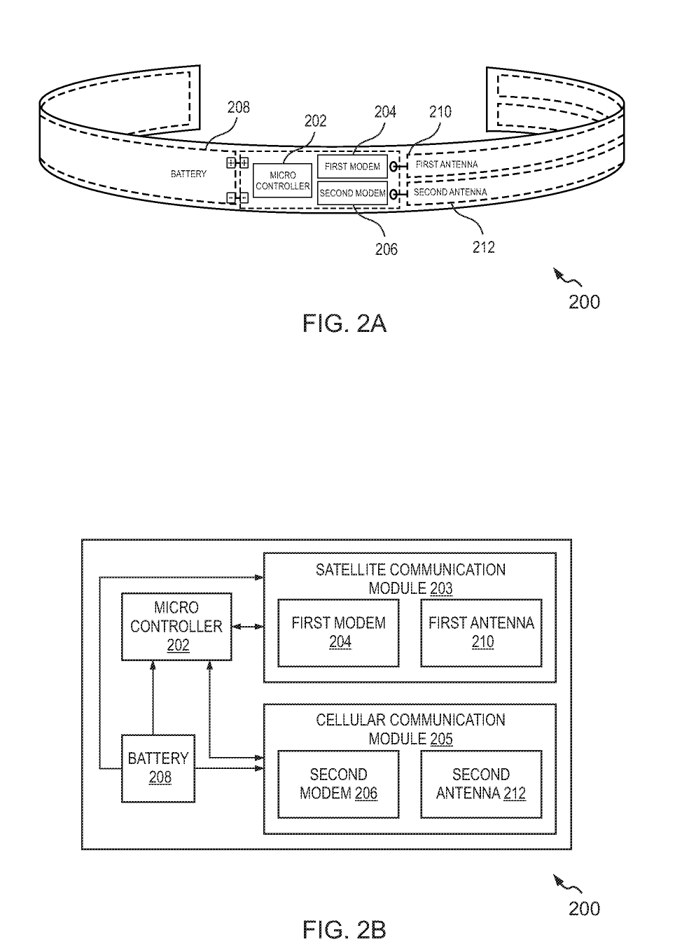

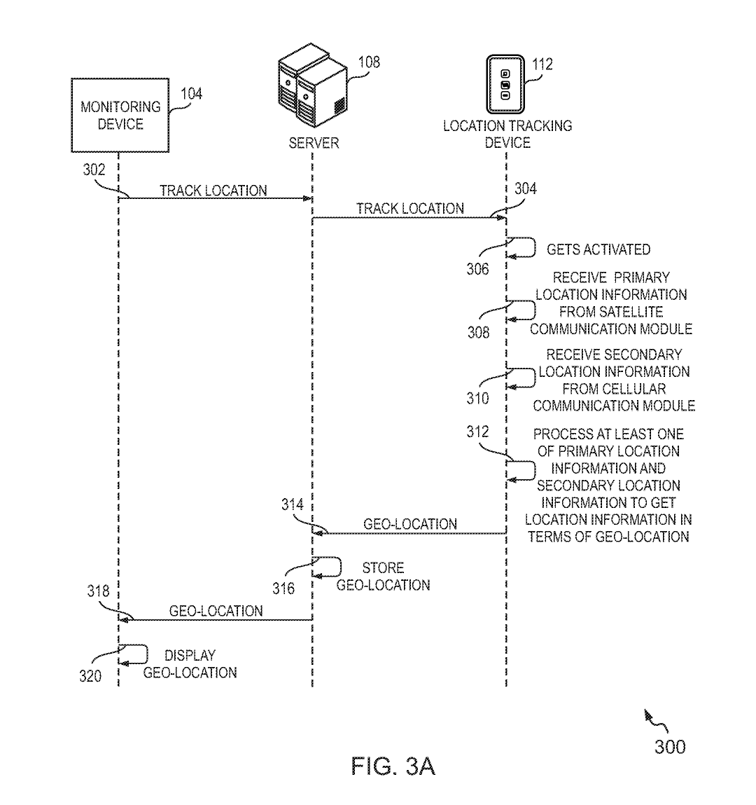

FIGS. 2A, 2B illustrate schematic representations of a location tracking device 200 in accordance with an example embodiment. As seen from FIG. 2A, the location tracking device 200 has a thin strip-like profile and can be easily concealed in wearables, such as a garment or an accessory of a user (e.g., the user 110) for facilitating real-time location tracking of the user. In an example, the location tracking device 200 is concealed within a waist band of track pant worn by the user. The location tracking device 200 comprises a microcontroller 202, a satellite communication module 203, a cellular communication module 205 and a battery 208.

The satellite communication module 203 comprises a first modem 204 and a first antenna 210. The first antenna 210 can be a satellite antenna that is configured to receive a plurality of satellite signals from one or more satellites (e.g., the satellites 116). An example of the first antenna 210 may be a horn antenna or a reflector antenna. The first modem 204 is electronically coupled with the first antenna 210. The first modem 204 is configured to receive the plurality of satellite signals from the first antenna 210 and determine a primary location information of the location tracking device 112 associated with the user. In an example, the first modem 204 determines the first location information of the location tracking device 200 in terms of latitude, longitude, altitude and time.

The cellular communication module 205 comprises a second antenna 212 and a second modem 206. The second antenna 212 is a cellular antenna that is configured to receive a plurality of cellular signals from one or more cellular towers (e.g., cellular towers 114) in a close vicinity of the location tracking device 200. The second modem 206 is electronically coupled with the second antenna 212 and is configured to determine the secondary location information of the user based on the plurality of cellular signals received from the second antenna 212. The second antenna 212 is communicably coupled to an external device, such as, the monitoring device 104 (see, FIG. 1) and is configured to communicate at least one of the primary location information and the secondary location information to the external device. In an example, the second modem 206 determines the second location information in terms of latitude, longitude, altitude and time.

In an embodiment, the first modem 204 and the second modem 206 are two different modems. In another embodiment, the first modem 204 and the second modem 206 is a single modem electronically coupled with both antennas i.e. the first antenna 210 of the satellite communication module 203 and the second antenna 212 of the cellular communication module 205. The modem facilitates in determining the primary location information and the secondary location information of the user based on the plurality of satellite signals and cellular signals received from the first antenna 210 and the second antenna 212, respectively.

The microcontroller 202 is electronically coupled to the satellite communication module 203 and the cellular communication module 205. The microcontroller 202 is configured to access the primary location information and the secondary location information from the first modem 204 and the second modem 206, respectively. In an embodiment, the microcontroller 202 is configured to receive a user request from the external device to track location information of the user associated with the location tracking device 200. Upon receipt of the user request, the microcontroller 202 initiates the satellite communication module 203 and the cellular communication module 205 to determine the primary location information and the secondary location information, respectively. Further, the microcontroller 202 is configured to enable communication of at least one of the primary location information and the secondary location information to the external device (e.g., the monitoring device 104) upon receipt of the user request via the second antenna 212. In an embodiment, the microcontroller 202 accesses the secondary location information of the user from the cellular communication module 205 only when the primary location information of the user is not accessible from the satellite communication module 203. For example, if the user associated with the location tracking device 200 is trekking in a mountainous region with thick forest cover and his/her family is not able to reach the user, then the whereabouts of the user can be tracked using the location tracking device 200. However, the primary location information from the satellite communication module 203 may not be available/accessible. In such cases, the microcontroller 202 enables the second antenna 212 of the cellular communication module 205 to communicate the secondary location information to the external device.

The battery 208 is a wireless chargeable battery and is configured to provide power required for operating the location tracking device 112. In an example, the battery 208 meets the power requirements of the microcontroller 202, the satellite communication module 203 and the cellular communication module 205. The battery 208 can be recharged wirelessly. In an embodiment, the battery 208 comprises a Qi charging coil for wirelessly charging the battery 208 via inductive charging. Alternatively, the battery 208 uses at least one of a magnetic resonance charging, a radio frequency charging, an ultrasonic sound wave charging or any other wireless charging technique known in the art, for wirelessly charging the battery 208.

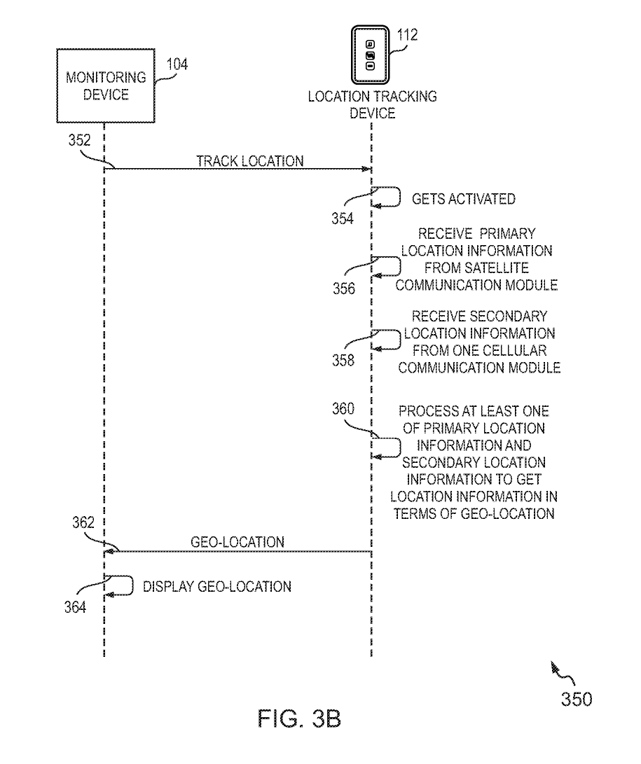

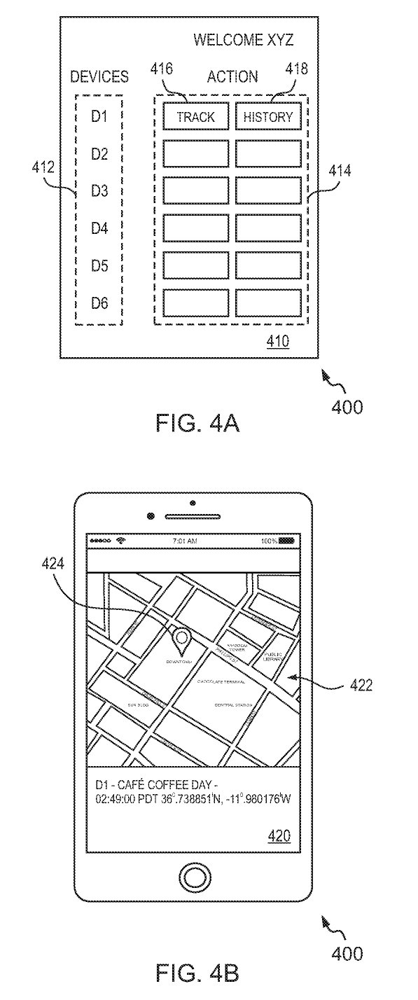

Referring now to FIG. 3A, a sequence flow diagram 300 for tracking location of a user associated with the location tracking device of FIG. 2B is illustrated in accordance with an example embodiment. The sequence of operations of the flow diagram 300 need not be necessarily executed in the same order as they are presented. Further, one or more operations may be grouped together and performed in form of a single step, or one operation may have several sub-steps that may be performed in parallel or in sequential manner.

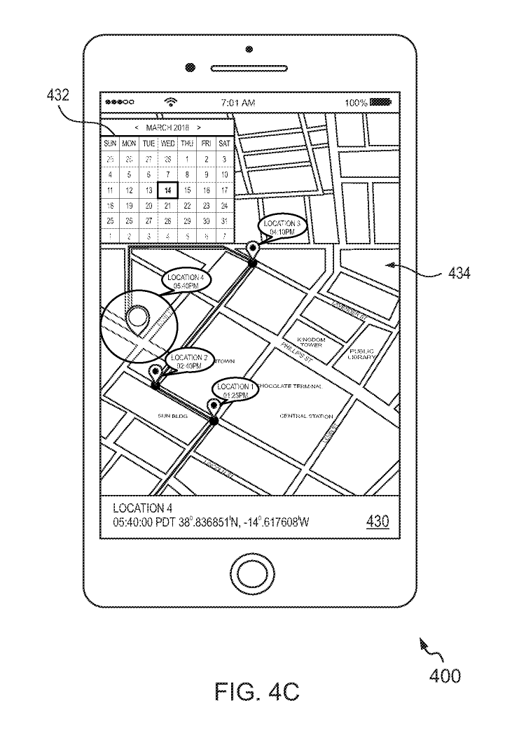

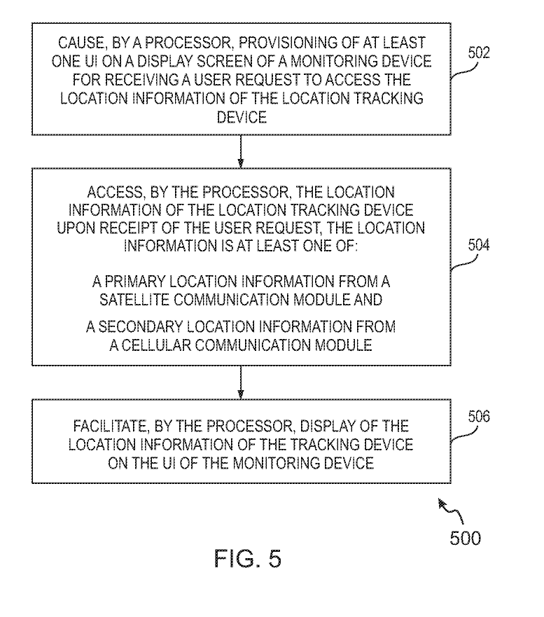

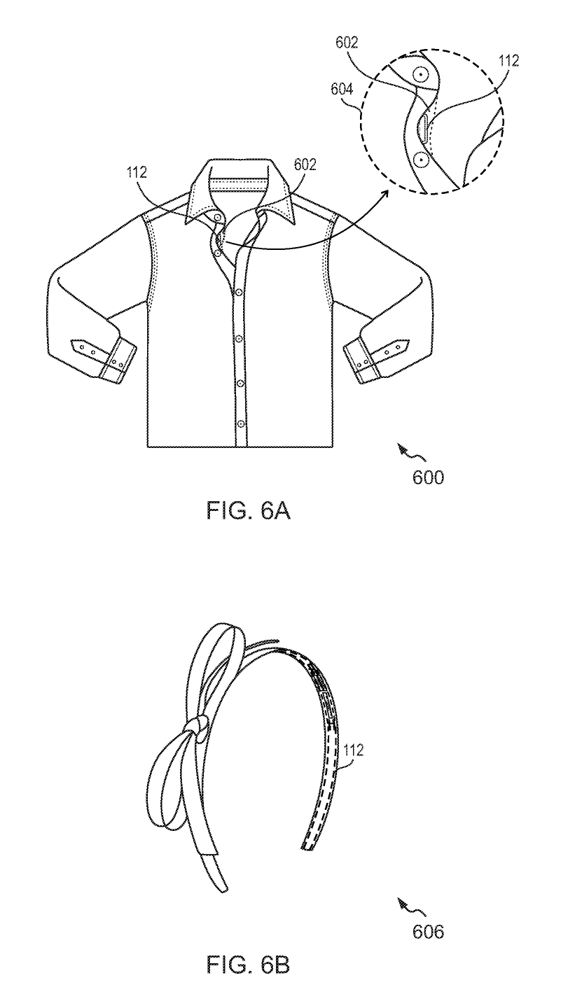

At operation 302, the monitoring device 104 sends a user request to the server 108 to track the location of the user associated with the location tracking device 112. In an example, if a user (e.g., the user 110) associated with the location tracking device 112 is kidnapped, then the user (e.g., the user 102) associated with the monitoring device 104 can accesses a tracking application, such as, the tracking application 118 installed in the monitoring device 104 to send the user request. In an embodiment, the tracking application 118 may present one or more UI's on the monitoring device 104 displaying a list of users associated with location tracking devices and the user 102 provides a selection input on the user 110 from the list of users to initiate tracking of the user 110 associated with the location tracking device 112. An example of receiving the user request to track location information of the user 110 is shown and explained with reference to FIG. 4A.

At operation 304, the server 108 initiates the location tracking device 112 to track location of the user and determine location information associated with the location tracking device 112 upon receipt of the user request from the monitoring device 104.

At operation 306, the location tracking device 112 gets activated and starts tracking location of the user. At operation 308, the location tracking device 112 determines a primary location information based on a plurality of satellite signals received from one or more satellites. In an example scenario, the location tracking device 112 may not be able to receive signals from the satellites (e.g., the satellites 116) due to some obstacles such as buildings, trees and sometimes by extreme atmospheric conditions. In such cases, operation 310 is performed.

At operation 310, the location tracking device 112 determines a secondary location information based on a plurality of cellular signals received from one or more cellular towers (e.g., the cellular towers 114).

At operation 312, the location tracking device 112 processes at least one of the primary location information and the secondary location information to determine the location information in terms of geo-location. For example, a processing module (e.g., the microcontroller 202) receives at least one of the primary location information and the secondary location information of the location tracking device 112 to determine geo-location of the user in terms of latitude, longitude, altitude and time.

At operation 314, the location tracking device 112 provides the geo-location of the user to the server 108. At operation 316, the server 108 optionally stores the geo-location of the user. In an embodiment, the geo-location stored in the server may be used to track location history information of the user associated with the location tracking device 112. The location history information of the user may be used to determine a path traversed by the user associated with the location tracking device 112.

At operation 318, the server 108 provides the geo-location of the user associated with the location tracking device 112 to the monitoring device 104. In an embodiment, the server 108 provides the geo-location to the tracking application 118 installed on the monitoring device 104.

At operation 320, the monitoring device 104 displays the geo-location of the user associated with the location tracking device 112 via the tracking application 118 installed on the monitoring device 104. The location information of the user associated with the location tracking device 112 may be displayed on a map, such as Google® maps. In an embodiment, the history location information may be displayed based on the user request on the tracking application 118. An example of displaying the location information of the location tracking device on the tracking application is shown and explained with reference to FIGS. 4B, 4C.

In some example embodiments, the server 108 may not be needed, and the location tracking device 112 and the monitoring device 104 can directly communicate to each other. One example representation of such workflow is explained with reference to FIG. 3B.

Referring now to FIG. 3B, a sequence flow diagram 350 for tracking location of a user associated with the location tracking device of FIG. 2B is illustrated in accordance with another example embodiment. The sequence of operations of the flow diagram 350 need not to be necessarily executed in the same order as they are presented. Further, one or more operations may be grouped together and performed in form of a single step, or one operation may have several sub-steps that may be performed in parallel or in sequential manner.

At operation 352, the monitoring device 104 sends a user request to the location tracking device 112 to track the location of the user associated with the location tracking device 112. In an embodiment, the tracking application 118 may present one or more UI's on the monitoring device 104 displaying a list of users associated with location tracking devices and the user 102 provides a selection input on the user 110 from the list of users to initiate tracking of the user 110 associated with the location tracking device 112.

At operation 354, the location tracking device 112 gets activated and starts tracking location of the user. At operation 356, the location tracking device 112 determines a primary location information based on a plurality of satellite signals received from one or more satellites. In an example scenario, the location tracking device 112 may not be able to determine the primary location information based on signals received from the satellites (e.g., the satellites 116) due to some obstacles such as buildings, trees and sometimes by extreme atmospheric conditions. In such cases, operation 358 is performed.

At operation 358, the location tracking device 112 determines a secondary location information based on a plurality of cellular signals received from one or more cellular towers (e.g., the cellular towers 114). At operation 360, the location tracking device 112 processes at least one of the primary location information and the secondary location information to determine the location information in terms of geo-location.

At operation 362, the location tracking device 112 provides the geo-location of the user to the monitoring device 104. At operation 364, the monitoring device 104 displays the geo-location of the user associated with the location tracking device 112 via the tracking application 118 installed on the monitoring device 104. The location information of the user associated with the location tracking device 112 may be displayed on a map, such as Google® maps. An example of displaying the location information of the location tracking device on the tracking application is shown and explained with reference to FIG. 4B.

FIGS. 4A, 4B and 4C are simplified representations of a tracking application 400 presented at the monitoring device 104. The tracking application 400 is an example of the tracking application 118 shown and explained in FIG. 1. In an embodiment, the tracking application 118 causes display of one or more user interfaces (UIs) for receiving user request to initiate tracking the location information of the location tracking device (e.g., the location tracking device 112) associated with a user, such as the user 110 and display the location information of the location tracking device. Example UIs displayed to the user 102 for provisioning user request and displaying the location information are shown in FIGS. 4A, 4B and 4C.

Referring now to FIG. 4A shows an example representation of a UI 410 displayed on the display screen of a monitoring device by the tracking application 118 for receiving user request to track a user, in accordance with an example embodiment. The tracking application 118 as described in FIG. 4A is accessible by a user (e.g., the user 102) on a monitoring device (e.g., the monitoring device 104). Similarly, UIs 420 and 430 of the tracking application 118 as described in the FIGS. 4B, 4C are accessible by the user on the monitoring device 104. In an example scenario, after downloading the tracking application 118 from the server 108 (shown in FIG. 1), an application icon (not shown) may be displayed to the user 102 on a display screen of the monitoring device 104. The user 102 may provide a selection input on the application icon to invoke the tracking application 118. The tracking application 118, after invoking, may present one or more UIs for creating an account of the user 102. In some example embodiments, the creation of a user account may be precluded.

The UI 410 includes a left section 412 and a right section 414. The left section 412 displays a list of location tracking devices (D1, D2 . . . D6). It shall be noted that the location tracking devices (D1, D2 . . . D6) may be identified by unique numbers specific to the devices or names of the user associated with the devices (D1, D2 . . . D6). Each of the devices D1, D2 . . . D6 may be concealed in a garment or an accessory of a user, such as the user 110 shown in FIG. 1. The user associated with the location tracking devices D1, D2 . . . D6 can be tracked using the tracking application 118 of the monitoring device 104. The right section 414 displays an action field under which a track tab 416 and a history tab 418 are provided for the device D1. It shall be noted that the UI 410 will present a track tab and a history tab for each of the devices D1, D2 . . . D6. Clicking on the track tab 416 will navigate the user to the UI 420 of the tracking application 400. The user can view current location of the user associated with the location tracking device D1 by clicking on the track tab 416. The UI 420 has been explained in detail with reference to FIG. 4B. The user can view the history location information of the device D1 by clicking on the history tab 418. Clicking on the history tab 418 will navigate the user to the UI 430 shown and explained with reference to FIG. 4C. It shall further be noted that the location tracking devices D1, D2, . . . , D6 are shown for example purposes and the tracking application 118 may display fewer or more devices on the UI 410.

Referring now to FIG. 4B, an example representation of a UI 420 displaying location information of the location tracking device 112 associated with the user 110 is illustrated in accordance with an example embodiment. When a user (e.g., the user 102) associated with a monitoring device clicks on the track tab 416 corresponding to the device D1, the UI 420 depicting current location of the user associated with the tracking device D1 is presented on the tracking application 118. The UI 420 displays the current location 424 (Café' Coffee Day) of the user associated with the tracking device D1 on a map 422. The UI 420 also displays device name (D1), device location. time, and geo-location (latitude and longitude information) of the tracking device D1 at a bottom part of the page 420. As seen in FIG. 4B, the user associated with the location tracking device (D1) is found to be present at the location (36° 738.851′N, −11° 980.176′W, Cafe Coffee Day) at time (2:49 PDT).

Referring now to FIG. 4C, an example representation of a UI 430 displaying history location information of the tracking device of FIG. 2A is illustrated in accordance with an example embodiment. The UI 430 is presented on the tracking application 400 when a user associated with the monitoring device clicks on the history tab 418 corresponding to device D1 in the UI 410. The UI 430 presents history of the location information of a user (e.g., the user 110) associated with the tracking device D1. In an example, the UI 430 displays path traversed by the user 110. In an embodiment, the history location information is stored in a database of a server, such as the server 108 for later retrieval. The UI 430 includes a date tab 432 that displays a calendar on receiving a selection input from the user (e.g., the user 102) accessing the tracking application 400. The user 102 can provide a selection input on any of the day in the calendar to view history location information on that specific day (e.g., 14 Mar. 2018).

As seen in FIG. 4C, current location (Location 4) of the user associated with the location tracking device (D1) is displayed at bottom part of the UI 430. On selecting a day from the calendar using the date tab 432, the user 102 can see the location history of the user associated with the location tracking device (D1) on the selected date (14 Mar. 2018). In an example, if the user 102 selects the date 14 Mar. 2018, the locations covered by the location tracking device (D1) on 14 Mar. 2018 will be displayed to the user via a map 434 of the tracking application 400. As seen in FIG. 4C, the user associated with the device D1 had moved through Location 1, Location 2, Location 3 to Location 4 (current location). The dotted lines on the map 434 represent the path traversed by the user associated with the location tracking device (D1) and a circled location (Location 4) will represent the current location of the user associated with the location tracking device (D1) on 14 Mar. 2018.

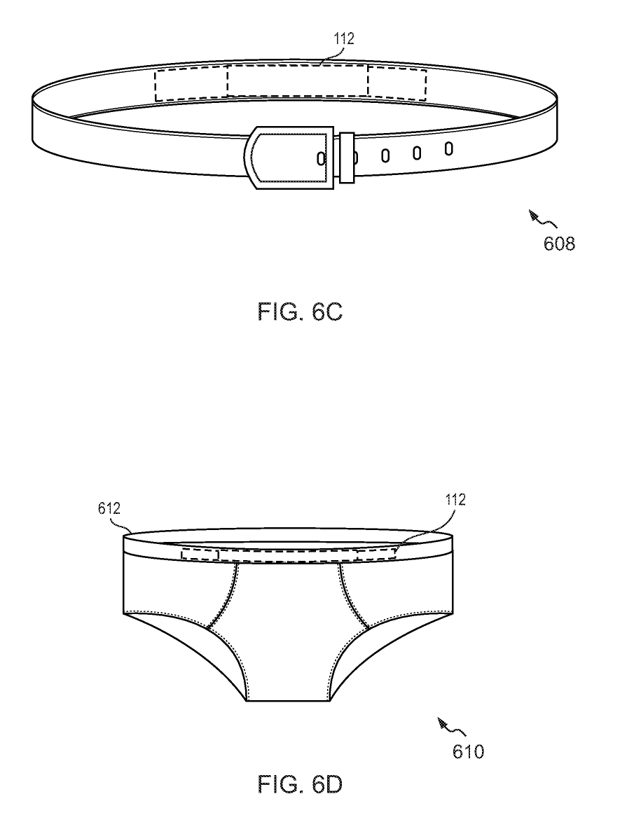

FIG. 5 is a flowchart illustrating a method 500 for determining location information of a user associated with a location tracking device, in accordance with an example embodiment. The operations of method 500 may be carried out by a server such as the server 108 or by the monitoring device 104. The sequence of operations of the method 500 may not be necessarily executed in the same order as they are presented. Further, one or more operations may be grouped together and performed in form of a single step, or one operation may have several sub-steps that may be performed in parallel or in sequential manner.

At operation 502, the method 500 includes causing, by a processor, a provisioning of at least one user interface (UI) on a display screen of a monitoring device for receiving a user request to determine the location information of a location tracking device. The location tracking device is concealed in an apparel or an accessory associated with a user (e.g., the user 102). The location information of the location tracking device can be tracked on a tracking application (e.g., the tracking application 118) installed on a mobile device such as, the monitoring device 104. The tracking application displays one or more UI's to receive the user request for tracking the location information of a location tracking device associated with a user. An example of a UI configured to receive user request is shown and explained with reference to FIG. 4A.

At operation 504, the method 500 includes accessing, by the processor, the location information of the location tracking device upon receipt of the user request. For example, the processor initiates the location tracking device to determine location information of the location tracking device. In an embodiment, the location information is at least one of a primary location information from a satellite communication module and a secondary location information from a cellular communication module. The satellite communication module receives a plurality of satellite signals from one or more satellites to determine the primary location information and the cellular communication module receives a plurality of satellite signals to determine the secondary location. In an embodiment, the secondary location information is accessed only if the primary location information is not available.

At operation 506, the method 500 includes facilitating, by the processor, display of the location information of the tracking device on the UI of the monitoring device. In an embodiment, the current location is displayed on the tracking application in the form of map and/or geo-coordinates. An example of a UI displaying the current location of the user associated with the location tracking device is shown and explained with reference to FIG. 4B.

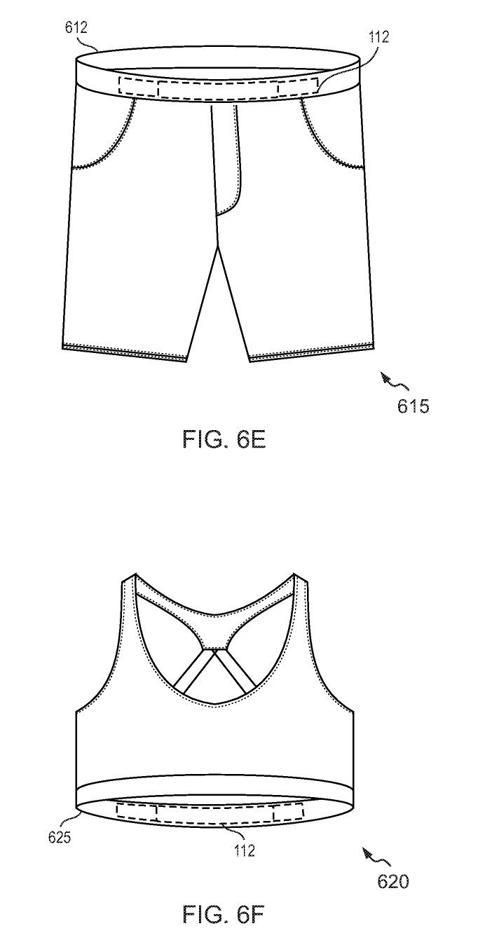

FIGS. 6A-6D illustrate example representations of concealing the location tracking device 112 in wearable objects, such as garments or accessories, in accordance with an example embodiment. The location tracking device 112 has a strip-like profile and is non-removably concealed in a concealing space provided at any portion of the garment or the accessory worn by a user (e.g., the user 110) whose location needs to be tracked.

As seen in FIG. 6A, the location tracking device 112 is concealed in a concealing space 602 provided at a buttoned placket of a shirt 600 the user is wearing. The concealing space 602 can be provided in any portion of the shirt such as cuff, collar, sleeve placket etc., and is not limited to the buttoned placket. An enlarged portion 604 shows an enlarged view of the location tracking device 112 concealed in the concealing space 602 provided at the buttoned placket of the shirt 600.

As seen in FIG. 6B, the location tracking device 112 is concealed in a headband 606 that may be worn on the head of the user. FIG. 6C depicts the location tracking device 112 concealed within a portion of a belt 608. FIGS. 6D and 6E represent the location tracking device 112 concealed within a waist band 612 of an undergarment 610 and a pair of shorts 615, respectively. FIG. 6F illustrates the location tracking device 112 concealed within a portion of a band 625 of an undergarment 620.

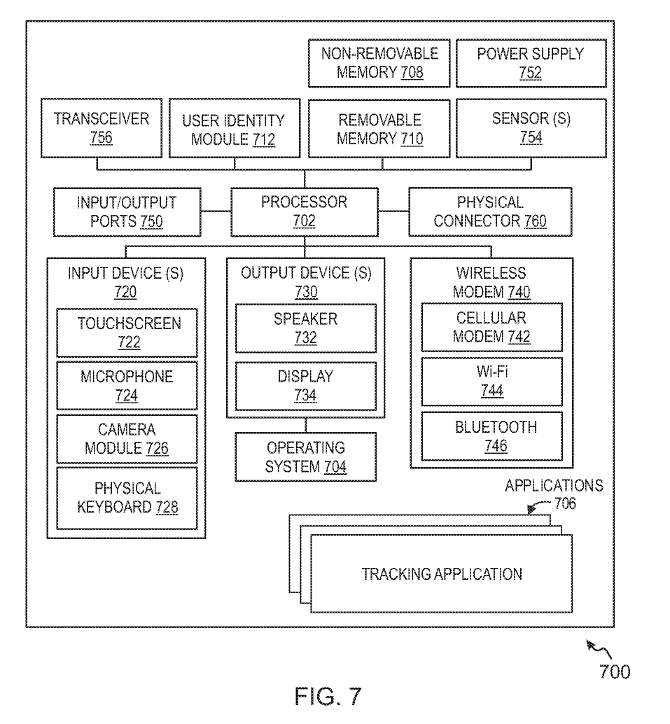

FIG. 7 shows a simplified block diagram of a mobile device 700, such as the monitoring device 104 explained with reference to FIG. 1. The mobile device 700, for example, can be a smartphone or a tablet computer capable of implementing the various embodiments of the present disclosure. The mobile device 700 is depicted to include a plurality of applications 706 including a tracking application.

It should be understood that the mobile device 700 as illustrated and hereinafter described is merely illustrative of one type of device and should not be taken to limit the scope of the embodiments. As such, it should be appreciated that at least some of the components described below in connection with that the mobile device 700 may be optional and thus in an example embodiment may include more, less or different components than those described in connection with the example embodiment of the FIG. 7. As such, among other examples, the mobile device 700 could be any of a mobile electronic device or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated mobile device 700 includes a controller or a processor 702 (e.g., a signal processor, microprocessor, ASIC, or other control and processing logic circuitry) for performing such tasks as signal coding, data processing, image processing, input/output processing, power control, and/or other functions. An operating system 704 control the allocation and usage of the components of the mobile device 700 and support for one or more applications programs (for example, the tracking application 118), that implements one or more of the innovative features described herein. The applications 706 may include common mobile computing applications (e.g., telephony applications, email applications, calendars, contact managers, web browsers, messaging applications such as USSD messaging or SMS messaging or SIM Tool Kit (STK) application) or any other computing application. The tracking application is configured to be in operative communication with other applications for example, through the OS or using API Calls, for tracking a tracking device (e.g., the location tracking device 112) associated with a user. Moreover, the tracking application communicates with the tracking device to display device location and device time to in substantially real-time. In at least one example embodiment, the tracking application is configured to determine location information of the user associated with the location tracking device 112 as explained with reference to FIGS. 1 to 4A-4C.

The illustrated mobile device 700 includes one or more memory components, for example, a non-removable memory 708 and/or a removable memory 710. The non-removable memory 708 and/or the removable memory 710 may be collectively known as database in an embodiment. The non-removable memory 708 can include RAM, ROM, flash memory, a hard disk, or other well-known memory storage technologies. The removable memory 710 can include flash memory, smart cards, or a Subscriber Identity Module (SIM). The one or more memory components can be used for storing data and/or code for running the operating system 704 and the applications 706. The mobile device 700 may further include a user identity module (UIM) 712. The UIM 712 may be a memory device having a processor built in. The UIM 712 may include, for example, a subscriber identity module (SIM), a universal integrated circuit card (UICC), a universal subscriber identity module (USIM), a removable user identity module (R-UIM), or any other smart card. The UIM 712 typically stores information elements related to a mobile subscriber. The UIM 712 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The mobile device 700 can support one or more input devices 720 and one or more output devices 730. Examples of the input devices 720 may include, but are not limited to, a touch screen/a display screen 722 (e.g., capable of capturing finger tap inputs, finger gesture inputs, multi-finger tap inputs, multi-finger gesture inputs, or keystroke inputs from a virtual keyboard or keypad), a microphone 724 (e. g., capable of capturing voice input), a camera module 726 (e.g., capable of capturing still picture images and/or video images) and a physical keyboard 728. Examples of the output devices 730 may include, but are not limited to a speaker 732 and a display 734. Other possible output devices can include piezoelectric or other haptic output devices. Some devices can serve more than one input/output function. For example, the touch screen 722 and the display 734 can be combined into a single input/output device.

A wireless modem 740 can be coupled to one or more antennas (not shown in the FIG. 7) and can support two-way communications between the processor 702 and external devices, as is well understood in the art. The wireless modem 740 is shown generically and can include, for example, a cellular modem 742 for communicating at long range with the mobile communication network, a Wi-Fi compatible modem 744 for communicating at short range with an external Bluetooth-equipped device or a local wireless data network or router, and/or a Bluetooth-compatible modem 746. The wireless modem 740 is typically configured for communication with one or more cellular networks, such as a GSM network for data and voice communications within a single cellular network, between cellular networks, or between the mobile device 700 and a public switched telephone network (PSTN).

The mobile device 700 can further include one or more input/output ports 750, a power supply 752, one or more sensors 754 for example, an accelerometer, a gyroscope, a compass, or an infrared proximity sensor for detecting the orientation or motion of the mobile device 700, a transceiver 756 (for wirelessly transmitting analog or digital signals) and/or a physical connector 760, which can be a USB port, IEEE 1294 (FireWire) port, and/or RS-232 port. The illustrated components are not required or all-inclusive, as any of the components shown can be deleted and other components can be added.

The disclosed systems and methods with reference to FIGS. 1 to 6A-6F, or one or more operations of the method 500 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

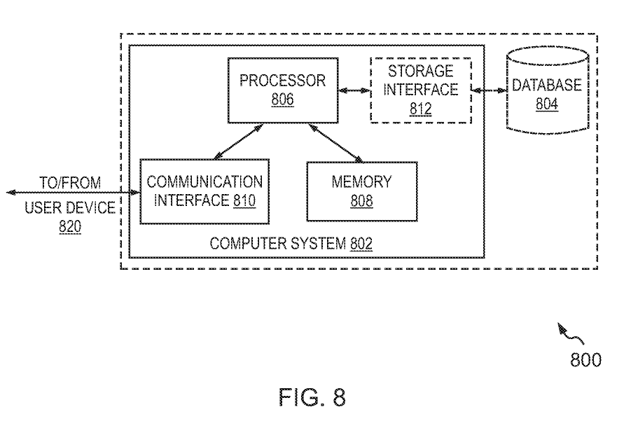

FIG. 8 is a block diagram of a server system 800, in accordance with an example embodiment. The server system 800 is an example of the server 108 shown and explained with reference to FIG. 1. The server system 800 includes a computer system 802 and one or more databases, such as a database 804.

The computer system 802 includes a processor 806 for executing instructions. Instructions may be stored in, for example, but not limited to, a memory 808. The processor 806 may include one or more processing units (e.g., in a multi-core configuration). The processor 806 is operatively coupled to a communication interface 810 such that the computer system 802 is capable of communicating with a remote device such as a user device 820. Some examples of the user device 820 may include, but are not limited to the monitoring device 104 and the location tracking device 112 shown in FIG. 1. The communication interface 810 is further configured to access a primary location information and a secondary location information of the location tracking device 112, compute current location of the user associated with the tracking device based on the primary location information and the secondary location information and facilitate display of the current location information.

The processor 806 may also be operatively coupled to the database 804 such as, but not limited to, plurality of applications. The database 804 is configured to store the tracking application 118 capable of tracking and displaying location information of a user associated with a tracking device as explained with reference to FIGS. 1 to 5. The database 804 is any computer-operated hardware suitable for storing and/or retrieving data. The database 804 may include multiple storage units such as hard disks and/or solid-state disks in a redundant array of inexpensive disks (RAID) configuration. The database 804 may include, but not limited to, a storage area network (SAN) and/or a network attached storage (NAS) system.

In some embodiments, the database 804 is integrated within the computer system 802. For example, the computer system 802 may include one or more hard disk drives as the database 804. In other embodiments, the database 804 is external to the computer system 802 and may be accessed by the computer system 802 using a storage interface 812. The storage interface 812 is any component capable of providing the processor 806 with access to the database 804. The storage interface 812 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 806 with access to the database 804.

The memory 808 is a storage device embodied as one or more volatile memory devices, one or more non-volatile memory devices, and/or a combination of one or more volatile memory devices and non-volatile memory devices, for storing micro-contents information and instructions. The memory 808 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general-purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application/or implementation without departing from the spirit or scope of the claims.

What is claimed is:

1. A location tracking system, comprising:
a wearable object configured to be worn by a user, the wearable object comprising a concealing space therein; and
a location tracking device configured to be concealed within the concealing space, the location tracking device having a strip-like profile and comprising:
a satellite communication module for determining a primary location information of the location tracking device;
a cellular communication module for
determining a secondary location information of the location tracking device, and
communicating with a monitoring device;
a microcontroller electronically coupled with the satellite communication module and the cellular communication module, the microcontroller configured to access a location information being at least one of the primary location information and the secondary location information and enable the cellular communication module to transmit at least one of the primary location information and the secondary location information to the monitoring device; and
a wireless chargeable battery for powering the location tracking device.

2. The location tracking system as claimed in claim 1, wherein the monitoring device comprises:
a tracking application configured to display at least one of the primary location information, the secondary location information and a history location information of the location tracking device.

3. The location tracking system as claimed in claim 2, wherein the microcontroller is further caused to:
receive a user request from the tracking application for tracking the user; and
prompt at least one of the satellite communication module and the cellular communication module to determine the location information.

4. The location tracking system as claimed in claim 2, wherein the tracking application is further caused to display the location information of the location tracking device on a map.

5. The location tracking system as claimed in claim 2, wherein the tracking application is further caused to display the location information of the location tracking device as geo-coordinates.

6. The location tracking system as claimed in claim 2, further comprising a modem electronically coupled with a first antenna of the satellite communication module and a second antenna of cellular communication module.

7. The location tracking system as claimed in claim 2, wherein the satellite communication module comprises:
a first antenna for receiving a plurality of satellite signals from one or more satellites; and
a first modem electronically coupled with the first antenna for determining the primary location information based on the plurality of satellite signals.

8. The location tracking system as claimed in claim 2, wherein the cellular communication module comprises:
a second antenna for receiving a plurality of cellular signals from one or more cellular towers and communicating at least one of the primary location information and the secondary location information to the tracking application; and
a second modem electronically coupled with the second antenna for determining the secondary location information based on the plurality of cellular signals.

9. The location tracking system as claimed in claim 1, wherein the microcontroller is configured to:
access the secondary location information if the primary location information is not accessible.

10. The location tracking system as claimed in claim 1, wherein the wireless chargeable battery uses at least one of an inductive charging, a magnetic resonance charging, a radio frequency charging and an ultrasonic sound wave charging for charging the wireless chargeable battery.

11. The location tracking system as claimed in claim 1, wherein the location tracking device is waterproof.

12. The location tracking system as claimed in claim 1, wherein the location tracking device is flexible.

13. The location tracking system as claimed in claim 1, wherein the wearable object is a wearable accessory.

14. A location tracking system, comprising:
a garment configured to be worn by a user, the garment comprising a concealing space therein;
a location tracking device configured to be concealed within the concealing space, the location tracking device having a strip-like profile and comprising:
a satellite communication module for determining a primary location information of the location tracking device;
a cellular communication module for determining a secondary location information of the location tracking device;
a microcontroller electronically coupled with the satellite communication module and the cellular communication module, the microcontroller configured to access a location information being at least one of the primary location information and the secondary location information; and
a wireless chargeable battery for powering the location tracking device; and
a monitoring device communicably coupled with the location tracking device for receiving from the cellular communication module at least one of the primary location information and the secondary location information to the monitoring device.

15. The location tracking system as claimed in claim 14, wherein the monitoring device further comprises:
a tracking application configured to display at least one of the primary location information, the secondary location information and a history location information of the location tracking device.

16. The location tracking system as claimed in claim 15, wherein the satellite communication module comprises:
a first antenna for receiving a plurality of satellite signals from one or more satellites; and
a first modem electronically coupled with the first antenna for determining the primary location information based on the plurality of satellite signals.

17. The location tracking system as claimed in claim 14, further comprising a modem electronically coupled with a first antenna of the satellite communication module and a second antenna of cellular communication module.

18. The location tracking system as claimed in claim 15, wherein the cellular communication module comprises:
a second antenna for receiving a plurality of cellular signals from one or more cellular towers and communicating at least one of the primary location information and the secondary location information to the tracking application; and
a second modem electronically coupled with the second antenna for determining the secondary location information based on the plurality of cellular signals.

19. The location tracking system as claimed in claim 14, wherein the wireless chargeable battery uses at least one of an inductive charging, a magnetic resonance charging, a radio frequency charging or an ultrasonic sound wave charging for wirelessly charging the wireless chargeable battery.

20. A method for determining a location information of a user associated with a location tracking device, the method comprising:
causing, by a processor, a provisioning of at least one UI on a display screen of a monitoring device for receiving a user request to access the location information of the location tracking device;
accessing, by the processor, the location information of the location tracking device upon receipt of the user request, the location information is at least one of:
a primary location information obtained from a satellite communication module; and
a secondary location information obtained from a cellular communication module, the secondary location information being accessed when the primary location information is not accessible; and
facilitating, by the processor, display of the location information of the tracking device on the UI of the monitoring device.

21. The method as claimed in claim 20, further comprising:
facilitating, by the processor, access of a tracking application installed on the monitoring device for providing the user request.
